(19) United States
(12) Patent Application Publication
(10) Pub. No.: US 2014/0362290 A1
(43) Pub. Date: Dec. 11, 2014

(54) FACILITATING GENERATION AND PRESENTATION OF SOUND IMAGES

(71) Applicant: HALLMARK CARDS, INCORPORATED, Kansas City, MO (US)

(72) Inventors: KEVIN J. BRIDGES, LEAWOOD, KS (US); SARA ELIZABETH RICHARD, KANSAS CITY, MO (US)

(21) Appl. No.: 13/911,771

(22) Filed: Jun. 6, 2013

(51) Int. Cl. H04N 5/60

(52) U.S. Cl. CPC H04N 5/60
USPC 348/484

(57) ABSTRACT

A system, method, and computer-readable media are described for facilitating generation and/or presentation of sound images. In one embodiment, a method of facilitating generation of sound images includes receiving a user selection of an image from a video. A user selection of an audio portion from the same video is also received. The selected image and the selected audio portion are associated with one another as a sound image such that the selected image and selected audio portion can subsequently be simultaneously presented as a still image with background audio.

### SUMMARY

Embodiments of the present invention enable generating and/or presenting sound images. A sound image refers to an image(s) associated with audio or sound, for example, both selected from a video. In this regard, embodiments of the present invention allow a user to select an image(s) from a video as well as an audio portion(s) from the same video. A selected image and audio portion can then be associated with one another to generate a sound image that, when presented, displays the still image and concurrently plays the audio in the background.

In a first illustrative embodiment, one or more computer-readable media having computer-executable instructions embodied thereon for performing a method of facilitating generation of sound images. The method includes receiving a user selection of an image from a video. The method also includes receiving a user selection of an audio portion from the same video. The method further includes associating the selected image and the selected audio portion with one another as a sound image such that the selected image and selected audio portion can subsequently be simultaneously presented as a still image with background audio.

In another illustrative embodiment, one or more computer-readable media having computer-executable instructions embodied thereon for performing a method of facilitating presentation of sound images. The method includes receiving a selection of a sound image for presentation, the sound image including an image selected by a user from a video and an audio portion selected by the user from the video. The method also includes displaying the image selected by the user from the video and concurrently playing the audio portion selected by the user from the video in accordance with the selection of the sound image for presentation.

In a third illustrative embodiment, a method of facilitating generation of sound images is provided. The method includes receiving a selection of an image frame from a video. A selection of an audio portion from the same video is also received. In embodiments, the selected image frame is from a different portion of the video than the selected audio portion. An image is extracted from the selected image frame of the video and the audio portion is extracted from the video. Using the extracted image and extracted audio portion, a sound image of a mixed-media format is generated that, when selected for presentation, is presented by simultaneously displaying a still image with background audio.

### BRIEF DESCRIPTION OF THE DRAWINGS

Illustrative embodiments of the present invention are described in detail below with reference to the attached drawing figures, which are incorporated by reference herein and wherein:

FIG. 1 is a drawing of an illustrative environment in which an embodiment of the present invention may operate;

FIG. 2 is a drawing illustrating a graphical user interface for managing sound images, in accordance with an embodiment of the present invention;

FIG. 3 is a drawing illustrating a graphical user interface for selecting to generate a sound image, in accordance with an embodiment of the present invention;

FIG. 4 is a drawing of a user interface for selecting a video for use in generating a sound image, in accordance with an embodiment of the present invention;

FIG. 5 is a drawing illustrating a user interface for selecting an image from a video, in accordance with an embodiment of the present invention;

FIG. 6 is a drawing illustrating a user interface allowing a user to select an audio portion from a video, in accordance with an embodiment of the present invention;

FIG. 7 is a drawing illustrating a user interface for enabling a user to select both an image and an audio portion from a video, in accordance with an embodiment of the present invention;

FIG. 8 is a drawing illustrating a user interface allowing a user to manage a newly created sound image, in accordance with an embodiment of the present invention;

FIG. 9 is a drawing illustrating a user interface including a new sound image, in accordance with an embodiment of the present invention;

FIG. 10 is a drawing illustrating a user interface for allowing a user to manage a selected sound image, in accordance with an embodiment of the present invention;

FIG. 11 is a drawing illustrating a user interface for allowing a user to delete a selected sound image, in accordance with an embodiment of the present invention;

FIG. 12 is a drawing illustrating a user interface for allowing a user to share a selected sound image, in accordance with an embodiment of the present invention;

FIG. 13 is a flow diagram in which a method of generating a sound image is described, in accordance with an embodiment of the present invention;

FIG. 14 is a flow diagram in which another method of generating a sound image is described, in accordance with an embodiment of the present invention; and

FIG. 15 is a flow diagram in which a method of presenting a sound image is described, in accordance with an embodiment of the present invention.

### DETAILED DESCRIPTION

Embodiments of the present invention provide systems and methods for facilitating generation and/or presentation of sound images. That is, embodiments of the present invention enable a user to generate and/or present a sound image. A sound image refers to an image(s) associated with audio or sound. In this regard, an image(s) can be presented along with background audio. In embodiments, the image(s) and associated audio for the sound image are selected from a video. As such, an image from a video can be displayed while an audio portion from the same video is played in the background.

Embodiments of the present invention may be embodied as, among other things: a method, system, or computer-program product. Accordingly, the embodiments may take the form of a hardware embodiment, a software embodiment, or an embodiment combining software and hardware. In one embodiment, the present invention takes the form of a computer-program product that includes computer-executable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include to information-delivery media, RAM, ROM, EEPROM, flash memory or other memory technology, CD-ROM, digital versatile discs (“DVD”), holographic media or other optical disc storage, magnetic cassettes, magnetic tape, magnetic disk storage, and other magnetic storage devices. These technologies can store data momentarily, temporarily, or permanently.

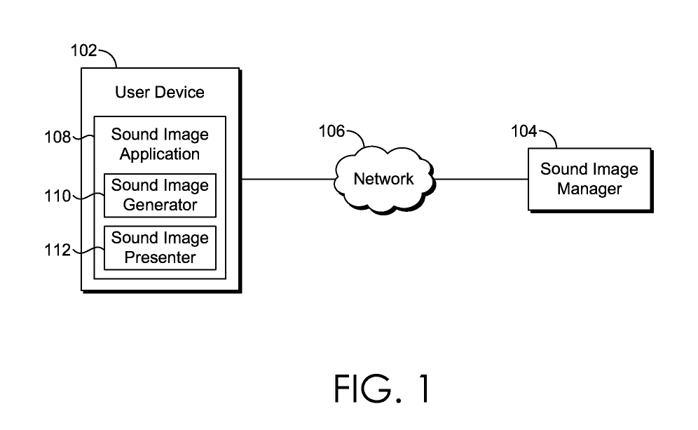

Embodiments of the present invention may be practiced in a communications network providing service to devices communicatively coupled to the communications network. An illustrative operating environment 100 that contains a few of the components within such a communications network is shown in FIG. 1. The components shown in FIG. 1 are the primary components that embodiments of the invention may interact with during operation. The components shown in FIG. 1 are described in brief and with an emphasis on function for the sake of simplicity. The components within FIG. 1 are communicatively coupled to each other in a manner appropriate for carrying out their respective function within the illustrative operating environment 100. Embodiments of the present invention are not limited by the communication protocols or formats used to facilitate communications between components.

Illustrative operating environment 100 includes user device 102, sound image manager 104, and network 106. The user device 102 and the sound image manager 104 can communicate by way of network 106. Network 106 may include one or more mobile networks, one or more packet-based networks, including the Internet, and the public switched telephone network (“PSTN”). The various components within network 106 may be owned and/or operated by multiple entities, commercial or otherwise. The present invention is not limited to embodiments that include a wireless device or a wireless network. However, the present invention may operate in a wireless network and with wireless devices. Accordingly, a wireless network illustrates one possible operating environment.

User device 102 can be any device capable of communicating via network 106. In embodiments, user device 102 is a wireless terminal that is adapted to receive communications and media over a network 106, such as a wireless network, included in illustrative operating environment 100. Some lower-level details of user device 102 are not shown so as to not obscure embodiments of the present invention. For example, user device 102 may include a bus that directly or indirectly couples the following devices: memory; one or more processors; one or more presentation components such as a display or speaker; input/output (I/O) ports; I/O components; and a power supply such as a battery. User device 102 may communicate via wireless protocols, such as code division multiple access (“CDMA”), global system for mobile communications (“GSM”), or time division multiple access (“TDMA”), as well as others, to communicate with a base station.

User device 102 may take on any of a variety of forms. By way of example, user device 102 may be a mobile telephone, smart phone, laptop computing device, desktop computing device, server, personal digital assistant (“PDA”) or any combination of these or other devices. The user device 102 may be associated with a user. The user is the ultimate recipient of communications (e.g., emails, phone calls, text messages) and content sent to user device 102.

The sound image manager 104 may be a combination of hardware and software. Such a sound image manager 104 may, in some embodiments, be used for transmitting web pages, applications, and/or other content (e.g., sound images) to a requesting device, or a portion thereof (e.g., web browser or application). The hardware aspect includes a computing device that includes a CPU, short-term memory, long-term memory, and one or more network interfaces. A network interface is used to connect to a LAN, WAN (including the Internet), or other variety of communication network, such as network 106. The network interface to the WAN or LAN could be wired, wireless, or both. Software on the sound image manager 104 allows communication with other computers connected to a common network through the network interface. The software facilitates receiving requests, retrieving the requested data, and transmitting the requested data to the requesting device, or portion thereof. The software may also provide security and authentication functions. The sound image manager 104 includes a variety of computer-readable media and the ability to access and execute instructions contained on the media. The above description of hardware and software is illustrative only; many other features were not listed so as to not obscure embodiments of the present invention.

In operation, sound images can be generated and/or presented at the user device 102 and/or a device remote from the user device 102, such as the sound image manager 104 or another user device (not shown). As previously described, a sound image refers to an image(s) associated with audio or sound. In this regard, an image(s) can be presented along with background audio. In embodiments, a still image(s) and associated audio for the sound image are selected from a video. As such, an image from a video can be displayed while an audio portion from the same video is played in the background. Although a sound image is generally described herein as including a still image and audio selected from a video, alternative embodiments are included with the scope of the invention. For example, a sound image might include multiple images (e.g., from a video) with an audio portion, an image from a first source (e.g., a first video or a photograph) and an audio portion from a second source (e.g., a second video), a combination thereof, or the like.

By way of example only, assume that a video is captured of an individual graduating from high school. In particular, assume that the video captures the individual obtaining his diploma as well as the ceremony processional with accompanying music of “Pomp and Circumstance.” Thereafter, a sound image can be created that enables presentation of an image of the individual obtaining his diploma while the selected audio portion of “Pomp and Circumstance” plays as background music.

Facilitating generation and/or presentation of sound images via a user device can be performed using various types of technology. For example, an application, such as a mobile application, that is installed, activated, and/or downloaded onto the user device 102 can be used to generate and/or present sound images. FIG. 1 illustrates a sound image application 108 hosted on the user device 102 that is configured to generate and/or present sound images. Although a sound image application 108 on the user device 102 is generally described herein for facilitating generation and/or presentation of sound images, as can be appreciated, the functionality of the components can be implemented alternatively or additionally through a website accessible via a web browser of the user device 102 and/or other applications. For example, as described in more detail below, upon a sound image being shared with another user, the sound image may be viewed via a website or application associated with the receiving user (e.g., a social network service, such as Facebook®; an email service; etc.).

The sound image application 108 on the user device 102 that facilitates generating and/or presenting sound image(s) can be obtained on the user device 102 in any number of ways. In one example, the sound image application 108 can be downloaded from a remote server, such as sound image manager 104, a website, or a mobile application store. In this regard, a user may provide an indication to obtain and/or utilize a sound image application. In response to such an indication, the sound image application can be requested from a server or other computing device that can provide the application, such as the sound image manager 104. In another example, the sound image application 108 may be included on the user device 102 at the time of purchase of the user device. The manner in which the sound image application 108 is obtained by the user device 102 is not intended to limit the scope of embodiments of the present invention.

In some cases, upon obtaining and initiating the sound image application 108 on the user device 102, terms and conditions can be presented via the display screen of the user device. Such a terms and conditions screen may prompt the user to accept the delineated terms and conditions associated with the sound image application 108 prior to utilization of the sound image application 108. Upon accepting the terms and conditions applicable to the sound image application 108, the user can utilize the application in any manner supported by the application.

A user may initially be prompted to register or log in to utilize the sound image application. In addition to general user data, such as a login identifier and password, data related to other accounts might be requested. For instance, a social network application login identifier and password might be requested to authenticate or authorize sharing or posting of a sound image.

As previously described, one embodiment of the sound image application 108 enables generation and/or presentation of sound images. As such, a user interface(s) provided by the sound image application 108 may allow a user to select which feature the user would like to utilize (e.g., sound image generator or sound image presenter). For example, a user may select whether he or she would like to generate a sound image or view a sound image previously generated by the user or received from another user. In cases that only one feature is provided or supported by a sound image application, such an option to select a feature may be unnecessary.

The sound image application 108 described in detail herein is used to generate and present sound images. In this regard, the sound image application 108 enables sound images to be created, viewed, and/or shared. In one embodiment, the sound image application 108 of the user device 102 illustrated in FIG. 1 includes a sound image generator 110 and a sound image presenter 112. As can be appreciated, in some embodiments, a sound image application can be configured to support any one or combination of features. For instance, a first sound image application on a user device may be configured to support generating sound images, and a second sound image application on the user device may be configured to support presenting sound images.

In some embodiments, one or more of the illustrated components may be implemented as stand-alone applications. In other embodiments, one or more of the illustrated components may be integrated directly into the operating system of the user device 102 or other computing device, such as sound image manager 104. It will be understood by those of ordinary skill in the art that the components illustrated in FIG. 1 are exemplary in nature and in number and should not be construed as limiting. Any number of components may be employed to achieve the desired functionality within the scope of embodiments hereof. Further, components may be located on any number of servers or computers.

The various features supported by the sound image application 108 are set forth in more detail below. Further, the sound image manager 104 can be utilized in conjunction with the sound image application 108 to facilitate generation and/or presentation of sound images. In this regard, the sound image application 108 on the user device 102 may communicate with the sound image manager 104 to access, obtain, and/or store data useful for creating or providing sound images.

The sound image generator 110 is configured to facilitate generating one or more sound images. In this way, the sound image generator 110 enables a user to initiate generation of sound images via the user device 102. As previously described, the functionality of the sound image generator 110 can be a stand-alone application, be part of the sound image application 108, or be provided via a website accessible via a web browser. In some embodiments, and as described in more detail below, the sound image generator 110 might access the sound image manager 104 to facilitate generating one or more sound images.

Generally, the sound image generator 110 receives an indication to generate a sound image. Such an indication can be provided in any number of manners and the particular manner employed is not intended to limit the scope of the present invention. In one embodiment, a user may initiate generation of a sound image by launching the sound image application 108. In another embodiment, a user may more specifically initiate generation of a sound image by selecting a generation icon. A generation icon refers to an icon that, if selected, initiates generation of a sound image. Examples of generation icons described below are exemplary in nature and are not meant to limit the scope of embodiments of the present invention.

By way of example, a user might initiate generation of a sound image by selecting a capture video icon that, when selected, enables a user to take a video for use in generating the sound image. In such a case, when a user selects to capture a video to be used for generating a sound image, the user device 102 can be used to capture a video. For instance, the sound image generator 108 can trigger launching the video camera of the user device 102 to begin capturing video. Any captured video can then be stored, for example, at the user device 102, remote from the user device (e.g., at the sound image manager 104), etc. In some implementations, such captured video might be specifically stored as a video for generating a sound image. In other implementations, such captured video might be stored as a video along with other videos generally captured by the user device. In such an implementation, the captured video is stored irrespective of utilization for a sound image.

Upon capturing the video, the captured video might automatically be selected for use in generating a sound image or the user might select to generate the sound image using the captured video. For instance, the user might select the recently captured video directly upon the video being captured or might perform a search for the recently captured video to thereafter select the video for generation of a sound image.

As another example, a user might initiate generation of a sound image by selecting an existing video icon that, when selected, enables a user to choose an existing video for use in generating the sound image. In this regard, when a user selects an existing video icon for use in generating the sound image, the user can be presented with one or more video representations that represent previously captured videos from which to generate the sound image. For example, representations of stored or preexisting videos can be displayed to the user allowing the user to select one of the representations. Such video representations might be in any form, such as a selected or predetermined still image from the video, a text indicator of the video (e.g., a title, a video caption, a video description, etc.), an icon or symbol representing the video, or the like. In some cases, before being presented with video representations, the user might be able to select a particular location or category of videos from which to select. For example, a user may be presented with categories of videos or various storage locations for which the user would like to be presented with corresponding videos. Such categories may include dates, times, labels/tags (e.g., individuals in video), seasons, topics (e.g., sports, performances, nature, family, etc.), or the like. Such storage locations may include a local storage location, a removable storage location, a remote storage location, or the like.

Upon displaying video representations, the user can select a particular video from which to generate a sound image. Such a selection can occur in any manner. For example, a particular video may be designated by a user selecting or touching the video representation associated with the video desired for generating a sound image. In some cases, upon selecting a video representation from among a plurality of video representations, the selected video can be played, for instance, to verify or determine that the particular video is desired for generating a sound image.

Irrespective of the method used to select a video from which to generate a sound image, upon selection of a video, or confirmation thereof, the sound image generator 110 facilitates selection of an image(s) and/or audio portion within the video for use in creating a sound image. In this regard, upon video selection, or confirmation thereof, the sound image generator 110 can present audio and/or image selection controls that can enable selection of audio and/or images, respectively. In some embodiments, the audio and image selection controls are simultaneously presented. In this way, an audio control(s) used to select an audio portion(s) and an image control(s) used to select an image(s) can be presented at the same time on the same display screen. In other embodiments, the audio and image selection controls are presented sequentially to one another. As such, image selection controls to select an image within the video might be presented and, upon selecting the image, audio selection controls might then be presented for selecting an audio portion of the video. Alternatively, audio selection controls to select an audio portion within the video might be presented and, upon selecting the audio, image selection controls might then be presented for selecting an image from the video.

The image selection control(s) allows or permits a user to select an image(s) for use in the sound image. As such, the sound image generator 110 can facilitate a user designating an image or set of images within the video for use in generating the sound image. A designated or selected image is a still image or content that the user desires to include or would like shown in relation to a sound image. Upon receiving selection of an image from the video, the image can be derived from, extracted from, formed from, or otherwise captured from the image designated by the user.

The particular image selected can be designated in any number of ways. For example, a user might be able to view the video and simply select an icon or the display to indicate a desired image. In other embodiments, a user might have a navigation component or control to utilize to select an image. For instance, a user may be able to slide a control forward or backward to a frame having content that the user would like to use in the sound image. In another example, a number of frames may be presented simultaneously such that the user can view multiple frames from the video and select one of the frames having content desired for use in a sound image.

The audio selection control(s) allows or permits a user to select an audio portion for use in the sound image. As such, the sound image generator 110 can facilitate a user designating an audio portion or set of audio portions within the video for use in generating the sound image. A designated audio portion is an audio portion of the video that the user desires to include or would like presented in relation to a sound image. Upon receiving an audio selection from a video, the audio can be derived from, extracted from, formed from, or otherwise captured from the audio portion selected by the user.

The particular audio portion(s) selected can be designated in any number of ways. For example, a user might be able to view the video and simply select an icon or the display to indicate a desired audio portion. In other embodiments, a user might have a navigation component or control to utilize to select an audio portion. For instance, a user may be able to slide a control forward or backward to an audio portion that the user would like to use in the sound image. In another example, a number of audio portion representations may be presented such that the user can selectively listen to audio portions from the video and select one of the audio portions therefrom. In yet another embodiment, an audio navigation control might enable audio to skip (e.g., sequentially) between various portions of the audio such that the user can listen to such audio portions. For example, each user selection of an audio skip icon might skip the audio a predetermined length of audio.

By way of example only, an audio portion window can be slid along a sound wave section to select a sound segment the user would like to use. In some cases, the endpoints of the audio portion window can be moved independently for fine tuning such that the audio portion can be of varying lengths. As can be appreciated, in embodiments, a selected audio portion can be previewed, such as, for example, upon a user selection of a play icon.

As can be appreciated, in some embodiments, the selected audio portion and the selected image from a video do not align or correspond with one another. In this regard, the image selected for display is from a different part, portion, or timeframe of the video than the audio portion selected for background audio. In other words, prior to creation of the sound image, at the time a selected image is displayed within the video, a user would not hear any portion of the selected audio. Stated differently, a user listening to the selected audio portion of the video (when not viewing a sound image) would not see the selected image being displayed during presentation of the specific audio.

In accordance with selecting a desired image(s) and audio portion(s), a sound image can be generated. In this regard, the image(s) and audio portion(s) are associated with one another for simultaneous presentation to a user(s). A sound image can be generated and/or formatted in any number of ways, some of which are described herein.

In one embodiment, the selected image(s) and audio portion(s) are stored as separate files. In this regard, the selected image(s) can be stored in an image file format and the selected audio portion can be stored in an audio file format. For instance, a selected image can be converted to and stored as an image file format, such as JPEG (Joint Photographic Experts Group) or JFIF (JPEG File Interchange Format). Other image file formats that may be used include, but are not limited to, JPEG2000, EXIF (Exchangeable Image File Format), TIFF (Tagged Image File Format), GIF (Graphics Interchange Format), or the like. Any two-dimensional or three-dimensional uncompressed, compressed, or vector formats are within the scope of embodiments of the present invention. A selected audio portion can be converted to and stored as an audio file format, such as, for example, M4A, MP3, AIFF, WAV, MP4, or the like. Any compressed or uncompressed audio file formats are within the scope of embodiments of the present invention.

In such an embodiment, although stored as separate files, the audio file and the image file are associated with one another. Such an association may occur in any manner. For example, an index or table may be created to include associations of images and audio portions such that when selected for presentation, the appropriate image(s) and audio portions can be accessed and presented. In another example, metadata corresponding with one or both of the image and audio portion may indicate such an association.

In another embodiment, the selected image(s) and audio portion(s) are combined into a single file for storage and/or presentation. In some cases, the selected image(s) and audio portion can be stored and presented as a single file that supports both an image and an audio portion. The selected image and audio portion are associated with one another and included in a single file (e.g., mixed-media file) that includes the image and audio information contained or embedded therein. In other cases, the selected image(s) and audio portion can be stored and presented as a single format that supports video content, such as MOV. In this way, the selected image can be repeated as multiple frames of the video while the selected audio portion is playing such that the selected image appears as a still image to the user while the user hears the background audio.

The single file might be generated directly from the selected image(s) and audio(s) of the selected video. For instance, upon selecting an image and audio portion, such portions can be extracted from the video and combined into a single file that supports the image and audio information. In other cases, the single file might be generated from an image file created for the selected image and an audio file created for the selected audio, as described above. Such a conversion from a separate image file and audio file to a single file including the image and audio may occur at any time. For example, in some embodiments, the separate files may initially be created and associated with one another as a sound image. At a later time, such as upon receiving an indication to share a sound image, the separate files might be converted to a single file, such as a .MOV file, to transmit to another component or device.

The generated sound image, in any form (e.g., a single file or multiple associated files), can be saved as a sound image for subsequent presentation. Sound images might be stored, for instance, at the user device 102, the sound image manager 104, or another component or device.

Upon generating a sound image, the sound image is available for presentation, such as display or communicating to another component or device. In some cases, the sound image, or data associated therewith (e.g., identification of sound image, time and date of sound image generation, an indication of selected image(s), an indication of the source video, an indication of selected audio portion, etc.), is stored on the user device 102. In other cases, the sound image, or data associated therewith, is stored at the sound image manager 104 or other remote computing device or component. Notwithstanding the location at which the sound image, or data associated therewith, is stored, the sound image can be subsequently accessed via the user device 102 to present the sound image.

The sound image presenter 112 is configured to facilitate presenting one or more sound images. In this way, the sound image presenter 112 enables a user to initiate, via the user device 102, presentation of sound images. As previously described, the functionality of the sound image presenter 112 can be a stand-alone application, be part of the sound image application 108, or be provided via a website accessible via a web browser. In some embodiments, and as described in more detail below, the sound image presenter 112 might access the sound image manager 104 to facilitate generating one or more sound images.

Initially, the sound image presenter 112 receives an indication to present a sound image. Such an indication can be provided in any number of manners and the particular manner employed is not intended to limit the scope of the present invention. For example, a user may initiate presentation of a sound image by selecting a presentation icon to present a sound image in a desired manner. A presentation icon refers to any icon that, when selected, initiates presentation of a sound image. The presentation icon can correspond with various methods of presenting a sound image, such as playing the sound image, sharing the sound image, etc.

A sound image can be presented in any number of ways. By way of example only, a sound image might be presented by playing or providing the sound image via the user device 102. To play or provide a sound image at the user device 102, a user might select to play a sound image. Selecting a sound image for presentation can occur in any manner and is not intended to limit the scope of embodiments of the present invention. For instance, a sound image might be selected for presentation directly from a display screen provided upon generating the sound image.

In another instance, a sound image might be selected for presentation from among a set of previously generated sound images or a set of previously generated media files. By way of example only, representations of stored or preexisting sound images can be displayed to the user allowing the user select one of the sound image representations for presentation. Such a sound image representation might be in any form, such as the selected still image, a text indicator, an icon or symbol representing the sound image, or the like. In some cases, before being presented with sound image representations, the user might be able to select a particular location or category of sound images from which to select.

As can be appreciated, a list of sound images can be presented in any manner. In embodiments, sound images are listed in alphabetical order, in order of generation date, in order of most frequently played, in accordance with a search for a particular category of sound images (e.g., creator, individual in sound image, location associated with sound image, event associated with sound image, etc.). For each sound image representation displayed, any amount of information can also be provided. For example, an identification of the sound image (e.g., title), an image associated with the sound image, a sound image generation date, a sound image description or caption, or the like.

Upon receiving an indication to play a particular sound image, the sound image presenter 112 facilitates displaying and audibly playing the sound image, or a portion thereof. As the sound image, or data associated therewith, can be stored at the user device 102 and/or the sound image manager 104 (or other component), such data can be retrieved, received, or accessed from the appropriate location and thereafter provided for display and audio via the user device 102. In cases that the sound image is stored as a single file, the single file can be obtained. In cases that the sound image is stored as separate files for the audio and image, both of the associated files can be obtained. In such cases, a table, index, or other reference might be initially accessed to identify the associated files for the particular sound image.

The selected sound image(s) can be played in any number of manners. For example, the image and/or audio portion can be faded in and/or faded out. As another example, a selection of sound images can be played in a sequential series. Such a presentation permits a series, story, or slide-show style of presentation of multiple sound images subsequent to one another. Such a presentation may occur, for instance, upon a user selecting multiple sound images to view or upon a user selecting a sound-image story having multiple sound images associated therewith. A sound-image story refers to a group or plurality of sound images that are associated with one another, as indicated by a user. In this way, a user can group any number of sound images together to develop a series, story, or group of related sound images. The order of such a story can also be designated by a user such that the sound images are played in the designated sequence.

Although playing the sound image is generally described herein in relation to the user device 102 that generated the sound image, as can be appreciated, sound images can be visually and audibly presented on other devices. For example, as described in more detail below, a generated sound image can be shared such that another user device can play the sound image. In one implementation, the receiving device might utilize a sound image application to view the sound image. Alternatively or additionally, a receiving device might be able to play the sound image without accessing a sound image application. For example, the sound image might be initiated via a social networking website or application, an email application, or the like.

Additionally or alternatively to playing a sound image, a sound image might be presented by communicating the sound image to another device or component. For instance, a sound image might be provided to a social networking service for sharing with other users of the social networking service, an email service for sharing with designated recipients, a messaging service for sharing with designated recipients, other computing device, or the like. For example, a sound image might be posted, on Facebook® for others to view.

To communicate the sound image to another device or component, a user might select to share the sound image, for example, via email or a social network application. As can be appreciated, in some implementations, the user can designate the method or application for sharing the sound image.

Upon receiving an indication to share or communicate a sound image(s), the sound image presenter 112 can facilitate presenting the sound image to another component or device. Selecting a sound image for communication can occur in any manner and is not intended to limit the scope of embodiments of the present invention. For instance, a sound image might be selected for communication directly from a display screen provided upon generating the sound image. In another instance, a sound image might be selected for communication from among a set of previously generated sound images or a set of previously generated media files.

Upon receiving an indication to present a particular sound image(s), the sound image presenter 112 facilitates transmitting the sound image, or a portion thereof. As the sound image, or data associated therewith, can be stored at the user device 102 and/or the sound image manager 104 (or other component), such data can be retrieved, received, or accessed from the appropriate location and thereafter communicated via the user device 102 or the sound image manager 104. In cases that the sound image is stored as a single file, the single file can be obtained. In cases that the sound image as stored as separate files for the audio and image, both of the associated files can be obtained. In such cases, a table, index, or other reference might be initially accessed to identify the associated files for the particular sound image.

The sound image manager 104 is configured to manage sound image applications, and operations thereof. The sound image manager 104 might be a computing device, a server, a network of servers, a distributing system of computing devices or servers, or the like. Although sound image manager 104 is illustrated as a single component, any number of components or devices can be utilized to implement functionality described herein.

The sound image manager 104 can facilitate any functionality associated with sound image application 108 and is not intended to be limited to the functionality described herein. Initially, the sound image manager 104 might provide the sound image application 108 to the user device. In this regard, upon receiving an indication to utilize or download a sound image application, the sound image manager 104 can provide the requested application. In some cases, the sound image manager 104 might request and/or store user information prior to, upon, or in accordance with providing the sound image application 108.

In some embodiments, the sound image manager 104 may also facilitate generation of sound images. By way of example only, the sound image manager 104 could receive an indication of a video selected for generating a sound image, an indication of a particular image(s) within a video, and/or an indication of a particular audio portion from the same video. Upon receiving such selections, the sound image manager 104 generates a sound image by associating the selected image and audio portion with one another and/or creating a media file(s) including the selected image and audio portion. Additionally or alternatively, the sound image manager 104 might be configured to store sound images, such as sound images generated at the user device 102 and/or sound images generated at the sound image manager 104.

In additional or alternative embodiments, the sound image manager 104 might facilitate presentation of sound images. For instance, upon receiving an indication to play a sound image from a requesting user device, the sound image manager 104 might access the desired sound image stored in association therewith, and provide the selected sound image to the requesting device for presentation thereon. As another example, upon receiving an indication to communicate, transmit, or otherwise share a specific sound image, the sound image manager 104 might access the desired sound image stored in association therewith and, thereafter, transmit or communicate the sound image to the appropriate destination (e.g., user device, web server, application service, such as a social networking service or email service, or the like).

Although embodiments described herein are generally directed to utilizing a video to generate a sound image, in some cases, a still image not derived from a video can be paired with an audio portion to generate and/or present a sound image. Further, as can be appreciated, any number of images (e.g., multiple frames from a video) and/or audio portions can be selected for use in a sound image.

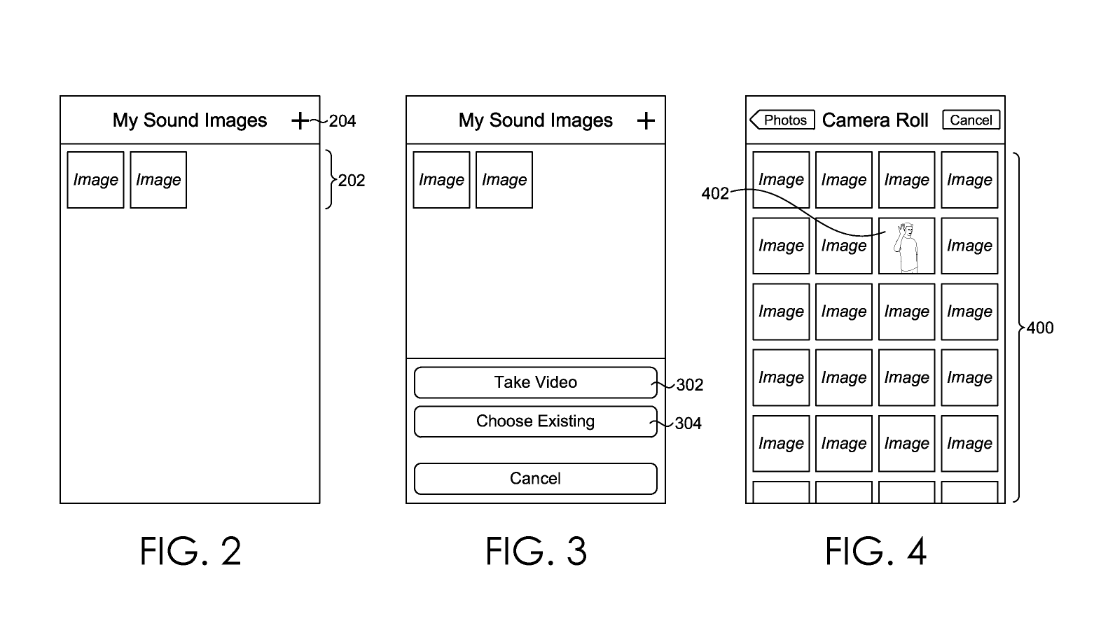

As can be appreciated, many different embodiments can be utilized to facilitate generation and/or presentation of sound images. FIGS. 2-12 provide an example of one implementation that can be employed by a sound image application, such as the sound image application 108, to enable a user to generate and present sound images. FIGS. 2-12 are provided merely for exemplary purposes and are not intended to limit the scope of embodiments of the invention.

Initially, after opening a sound image application, a user may select to play a sound image or generate a sound image. For example, and with reference to FIG. 2, the user may select a sound image from among a set of previously generated sound images 202 to play a sound image. Alternatively, the user may select to generate a sound image by selecting a generation icon 204.

Assume initially that a user wishes to generate a sound image and, as such, selects the generation icon 204 of FIG. 2. In such a case, as illustrated in FIG. 3, an option to generate a sound image from an existing video and an option to generate a sound image from a subsequently captured video are presented. As such, the user can select the “Take Video” icon 302 to capture a video from which a sound image is to be generated or select the “Choose Existing” icon 304 to generate a sound image from an existing captured video.

Now assume that the user would like to generate a sound image from an existing video. Accordingly, the user selects the “Choose Existing” icon 304 of FIG. 3. After selecting the “Choose Existing” icon 304, the user is presented with a set of video representations 400 that represent previously captured video, as shown in FIG. 4. Although FIG. 4 illustrates the video representations as an image from the video, the video representations can be presented in any manner or form. Further, prior to viewing a set of video representations indicating potential videos from which a sound image can be generated, a user might be presented with a display screen that can be used to navigate to a desired set of video representations. For example, a user may be presented with various storage locations from which to select, various categories or folders having associated videos, various media types (e.g., video or still images in the case that sound images can be made from still images), etc.

Assume now the user selects video representation 402 to indicate a desire to generate a sound image from the corresponding video. Such a selection of video representation 402 might occur in a number of says, such as, for example, a user touching the video representation 402. Upon selecting the video to use for generating a sound image, the user can select an image(s) and audio portion for use in generating the sound image.

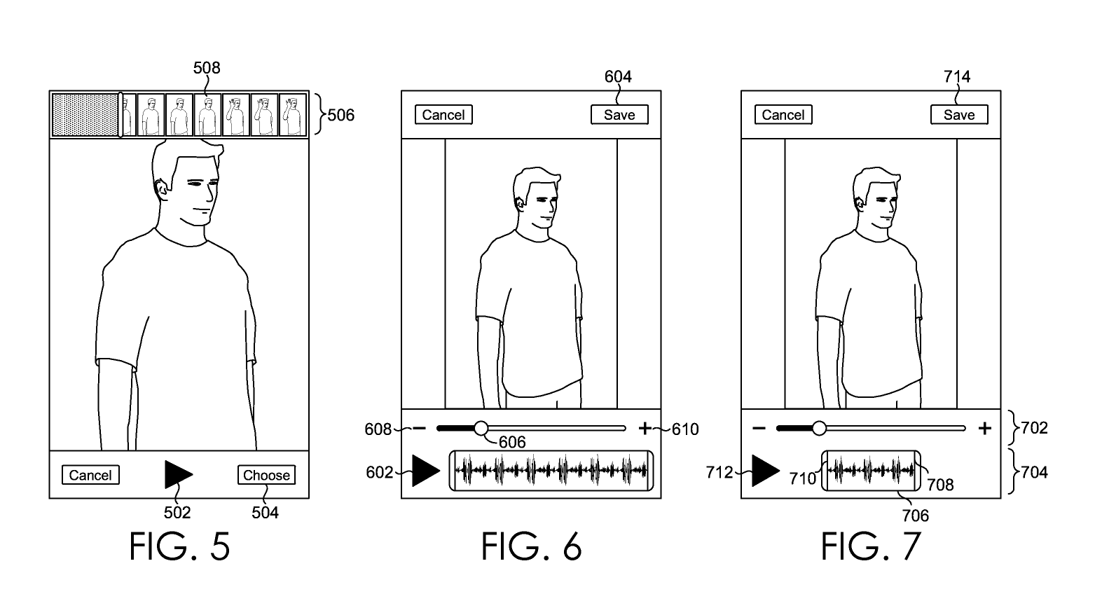

As illustrated in FIG. 5, the user has an opportunity to select an image within the video. As one example, the user may select the play button 502 to view the video and a stop button (not shown) to stop the video when the presented content is desired for a sound image. If the selected video content is desired, the user can select the “Choose” icon 504 to confirm use for generating a sound image. As another example, the user may select or scroll through a set of image frames 506 of the selected video to identify a video frame of interest. As such, the user might select video frame representation 508 to indicate or view the corresponding video frame. Other implementations could additionally or alternatively be employed for selecting an image, such as, for instance, utilization of a sliding control to view video frames of the video. Upon the user being satisfied with a particular image, the image can be selected or confirmed by selecting the “Choose” icon 504.

The user can also select the audio portion to be included in the sound image. For example, as illustrated in FIG. 6, the user may select the play button 602 to hear the audio and a stop button (not shown) to stop or pause the audio when the presented audio is desired for a sound image. In some cases, the corresponding video might be presented while the audio is played. In other cases, the selected still image might be presented while the audio is played. If the selected audio content is desired, the user can select the “Save” icon 604 to confirm use of selected audio for generating a sound image. As another example, the user may select or scroll through available audio using audio controls 606, 608, and/or 610 to identify an audio portion of interest. Other implementations could additionally or alternatively be employed for selecting audio, such as, for instance, utilization of a sliding control to listen to audio of the video. Upon the user being satisfied with a particular audio portion, the audio can be selected or confirmed by selecting the “Save” icon 604.

Although selecting an image(s) and audio is illustrated in FIGS. 5 and 6 as occurring on two different and subsequent user interface displays, in some embodiments, both the image(s) and audio can be selected on the same user interface display, as illustrated in FIG. 7. As shown, the user can utilize video control portion 702 to select an image(s) and audio control portion 704 to select an audio portion. For instance, a user can use the slider bar to scroll through and select the image desired to use from the video's frame. The “+” and “−” controls can be used for finer control. A user can also slide the highlighted window 706 in the sound wave section to select the sound segment desired for use in generating the sound image. The endpoints 708 and 710 can move independently for specifying the length, beginning point, and/or ending point of the desired audio portion. By selecting the play icon 712, the user can preview the selected sound. Upon being satisfied with the selected image and audio portion, the user can select the “Save” icon 714 to generate the sound image.

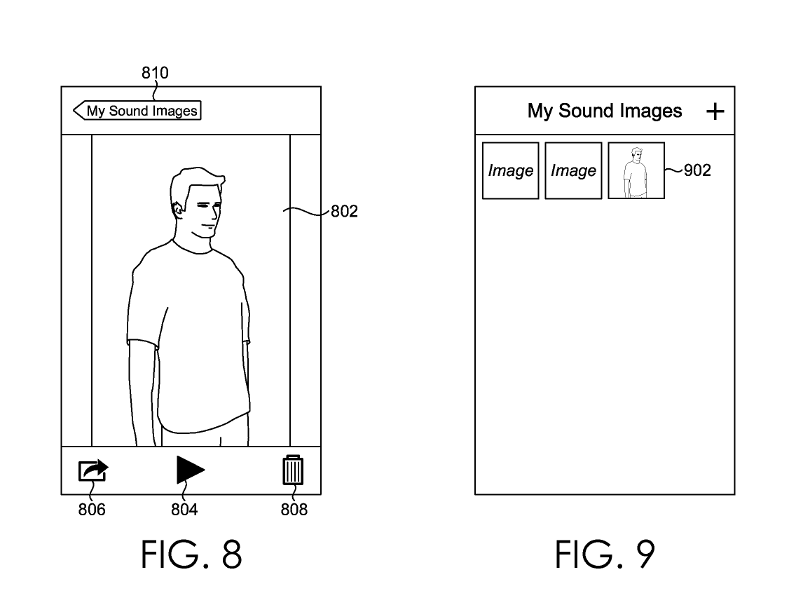

Irrespective of the method used to select an image and/or audio portion, upon confirming such selections, the sound image can be generated using the selected image and audio portion. As illustrated in FIG. 8, the generated sound image 802 is now available for playing, sharing, or deleting. For example, the user can select to play the sound image by selecting the play icon 804, share the sound image by selecting the share icon 806, or delete the sound image by selecting the delete icon 808, as described in more detail below. The user might also select the “My Sound Images” icon 810 to access sound images for playing or sharing, for example.

Upon generation of the sound image, as illustrated in FIG. 9, the sound image is available for use by the user, as shown by sound image representation 902. As such, the sound image representation 902 is available along with other generated sound images and can be accessed, for example, upon initiating the sound image application (as in FIG. 2), upon generating the sound image by selecting the “Save” icon 604 of FIG. 6 or 708 of FIG. 7, or the like.

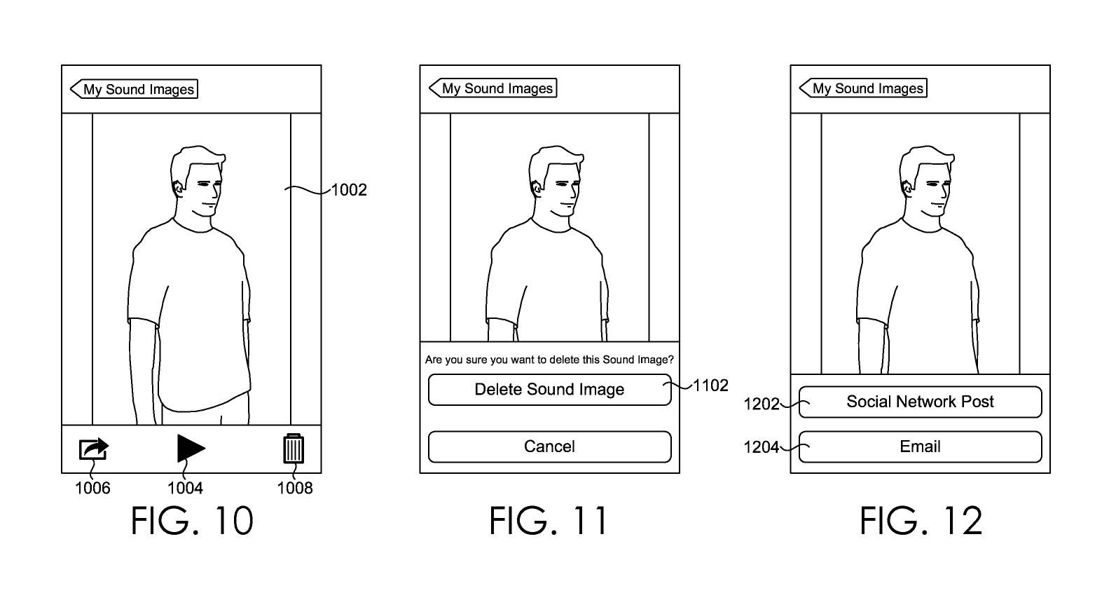

Now assume that the user would like to manage (e.g., view, share, delete) the sound image represented by sound image representation 902. As such, the user selects sound image representation 902. Thereafter, as illustrated in FIG. 10, the selected sound image 1002 is now available for playing, sharing, or deleting. For example, the user can select to play the sound image by selecting the play icon 1004, share the sound image by selecting the share icon 1006, or delete the sound image by selecting the delete icon 1008. In some cases, upon selecting sound image representation 902 of FIG. 9, the sound image automatically begins playing.

Assume the user selects to delete the sound image by selecting the delete icon 1008. As shown in FIG. 11, the user can be presented with a delete confirmation 1102 that, if selected, deletes of the sound image. Returning to FIG. 10, now assume that the user selects to share the sound image by selecting the share icon 1006. In such a case, as shown in FIG. 12, the user can be presented with options for sharing the sound image. For example, the user can be presented with a Social Network Post option 1202 to initiate a posting of the sound image via a Social Network application or website. As another example, the user can be presented with an email option 1204 to initiate an email including the sound image for sharing with one or more recipients. Similarly, although not illustrated, the user could share the sound image with one or more recipients using a Multimedia Messaging Service (MMS). In some cases, upon selecting a sharing option, the sound image can be automatically shared. In other cases, upon selecting a sharing option, the user may provide additional information to facilitate the sharing of the sound image. For example, the user may input a login identifier, a password, a corresponding message, a recipient, or the like.

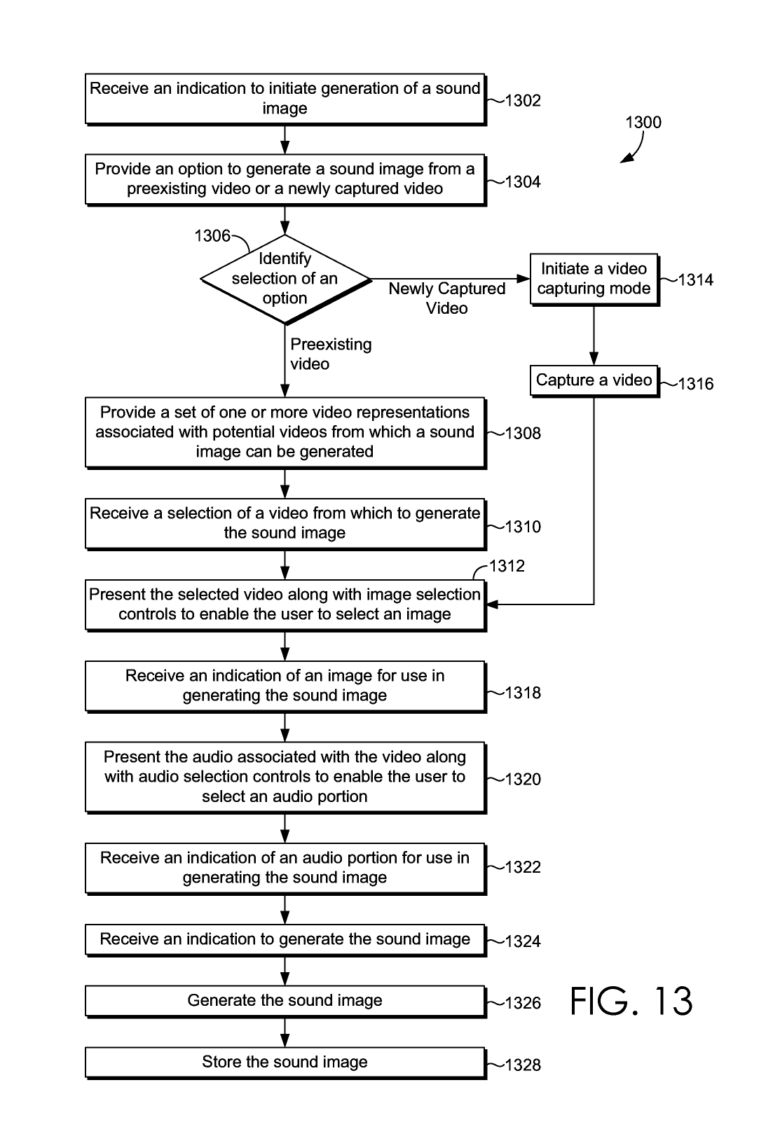

Turning now to FIGS. 13-15, flow diagrams illustrating various methods for implementing embodiments of the present invention are provided. With initial reference to FIG. 13, a flow diagram is illustrated showing a method 1300 for generating a sound image in accordance with an embodiment of the present invention. Method 1300 is but one example of a suitable method and is not intended to suggest any limitation as to the scope of the invention.

Initially, as indicated at block 1302, an indication to initiate generation of a sound image is received. At block 1304, an option to generate a sound image from a preexisting video or a newly captured video is provided. Subsequently, at block 1306, an identification is made of a selected option. In the case that a user selects to generate a sound image from a preexisting video, a set of one or more video representations associated with potential videos from which a sound image can be generated is provided, as indicated at block 1308. At block 1310, a video from which to generate the sound image is selected. The selected video is presented along with image selection controls to enable to the user to select an image. This is indicated at block 1312.

Returning to block 1306, if selection of capturing a new video from which to generate the sound image is identified, at block 1314, a video capturing mode is initiated. At block 1316, the video is captured. The method then proceeds to block 1312 at which the selected video (i.e., the newly captured video) is presented along with image selection controls to enable the user to select an image.

At block 1318, an indication of an image for use in generating the sound image is received. As indicated at block 1320, the audio along with audio selection controls to enable the user to select an audio portion are presented. An indication of an audio portion for use in generating the sound image is received, as indicated at block 1322. An indication to generate a sound image using the selected image and audio is received. This is indicated at block 1324. At block 1326, the sound image is generated. The sound image can be generated in any number of manners. Thereafter, at block 1328, the sound image is stored. As such, the sound image is available for subsequent presentation.

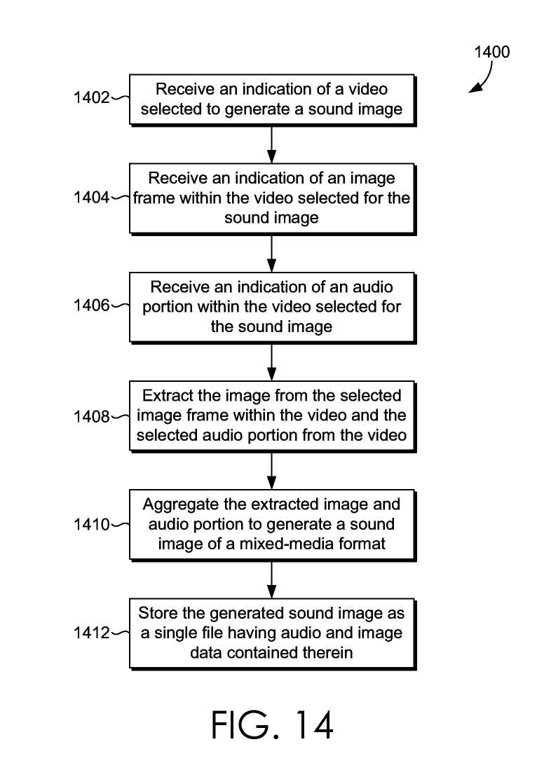

Turning now to FIG. 14, a flow diagram is illustrated showing another method 1400 for generating a sound image, in accordance with an embodiment of the present invention. Method 1400 is but one example of a suitable method and is not intended to suggest any limitation as to the scope of the invention. Initially, as indicated at block 1402, an indication of a video selected to generate a sound image is received. Thereafter, a selection of an image frame within the video is received for use in generating the sound image, as indicated at block 1404. A selection of an audio portion of the video is also received for use in generating the sound image, as indicated at block 1406.

Subsequently, at block 1408, the selected image and audio portion are extracted from the video. The extracted image and audio portion are aggregated to generate a sound image of a mixed-media format. This is indicated at block 1410. At block 1412, the generated sound image is stored as a single file having audio and image data contained therein. Although FIG. 14 describes the sound image as being generated as a single file, as can be appreciated, the sound image can be generated with the selected image and audio portions being generated as separate, but associated, files.

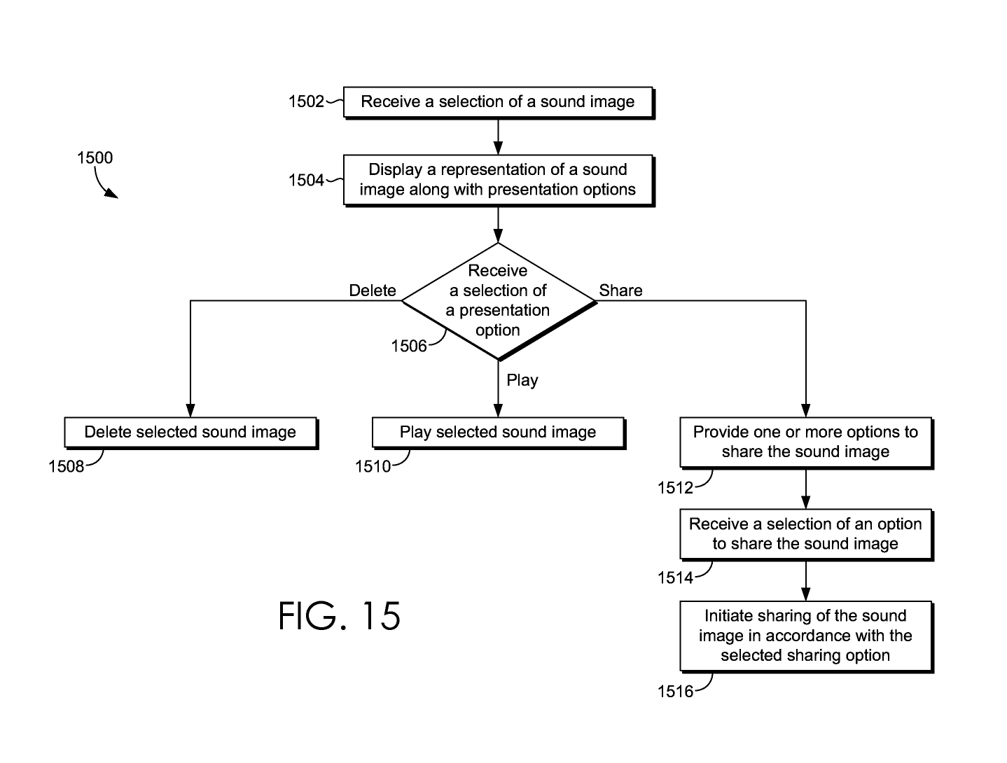

With reference to FIG. 15, a flow diagram is illustrated showing a method 1500 for presenting a sound image, in accordance with an embodiment of the present invention. Method 1500 is but one example of a suitable method and is not intended to suggest any limitation as to the scope of the invention. Initially, as indicated at block 1502, a selection of a sound image is received. Such a selection can occur in any manner, such as, for example, a user selection of a particular sound image from among a group of available sound images. Upon receiving a selection of a sound image, at block 1504, a representation of the selected sound image is displayed along with presentation options.

At block 1506, a selection of one of the displayed presentation options is received. In cases that a delete option is selected, at block 1508, the selected sound image is deleted. In cases that a play option is selected, at block 1510, the selected sound image is played (e.g., displayed and audibly played). In cases that a share option is selected, at block 1512, one or more options to share the sound image are provided. Thereafter, a selection of an option to share the sound image is received. This is indicated at block 1514. For example, a user may select to email, post, or message the sound image. In accordance with the selected sharing option, at block 1516, sharing of the sound image is initiated.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having computer-executable instructions embodied thereon for performing a method of facilitating generation of sound images, the method comprising:
receiving a user selection of an image from a video;
receiving a user selection of an audio portion from the same video; and
associating the selected image and the selected audio portion with one another as a sound image such that the selected image and selected audio portion can subsequently be simultaneously presented as a still image with background audio.

2. The media of claim 1, wherein the selected image and the selected audio portion are from different portions of the video.

3. The media of claim 1, wherein the user selection of the image from the video is based on a user selection of a video frame having content desired by the user for use in generating the sound image.

4. The media of claim 1 further comprising receiving an indication to generate the sound image.

5. The media of claim 4 further comprising receiving a selection of the video from among a plurality of videos for use in generating the sound image.

6. The media of claim 1 further comprising capturing the video based on a user indication to generate the sound image from a newly captured video.

7. The media of claim 1, wherein the sound image is of a single file format that includes data associated with the selected image and data associated with the selected audio portion.

8. The media of claim 1, wherein the sound image comprises an audio file that includes data associated with the selected audio portion and an associated image file that includes data associated with the selected image.

9. One or more computer-readable media having computer-executable instructions embodied thereon for performing a method of facilitating presentation of sound images, the method comprising:
receiving a selection of a sound image for presentation, the sound image including an image selected by a user from a video and an audio portion selected by the user from the video; and
in accordance with the selection of the sound image for presentation, displaying the image selected by the user from the video and concurrently playing the audio portion selected by the user from the video.

10. The media of claim 9, wherein the selected image is from a first portion of the video and the selected audio portion is from a second portion of the video, and wherein the first portion and the second portion of the video do not overlap with one another.

11. The media of claim 9 further comprising accessing the selected sound image for presentation, wherein the selected sound image comprises a single multi-media file that contains information associated with the selected image and the selected audio portion.

12. The media of claim 11, wherein the single multi-media file comprises a file format that supports an image and audio.

13. The media of claim 11, wherein the single multi-media file comprises a video file format with the selected image being repeated within a series of frames that extend through the selected audio portion to appear as a still image being displayed during presentation of the selected audio portion.

14. The media of claim 9 further comprising accessing the selected sound image for presentation, wherein the selected sound image comprises an image file containing information associated with the selected image and a corresponding audio file containing information associated with the selected audio portion.

15. A method of facilitating generation of sound images, the method comprising:
receiving a selection of an image frame from a video;
receiving a selection of an audio portion from the same video, wherein the selected image frame is from a different portion of the video than the selected audio portion;
extracting an image from the selected image frame of the video and the audio portion from the video; and
using the extracted image and extracted audio portion to generate a sound image of a mixed-media format that, when selected for presentation, is presented by simultaneously displaying a still image with background audio.

16. The method of claim 15, wherein the image frame and the audio portion are selected by a user via a user device.

17. The method of claim 15, wherein the mixed-media format comprises a file format that supports an image and audio.

18. The method of claim 15, wherein the mixed-media format comprises a video file format with the selected image being repeated within a series of frames that extend through the selected audio portion to appear as a still image being displayed during presentation of the selected audio portion.

19. The method of claim 15 further comprising receiving a selection to present the sound image.

20. The method of claim 15 further comprising receiving an indication to share the sound image.
